(19) United States
(12) Patent Application Publication
(10) Pub. No.: US 2025/0100405 A1
(43) Pub. Date: Mar. 27, 2025

(54) VEHICLE CHARGING DEVICE

(71) Applicants: YAZAKI CORPORATION, Tokyo (JP); ShinMaywa Industries, Ltd., Takarazuka-shi (JP)

(72) Inventors: Yukinari Naganishi, Susono-shi (JP); Koji Ikegaya, Susono-shi (JP); Takashi Shiroki, Susono-shi (JP); Masahiro Namba, Takarazuka-shi (JP); Hajime Ojiro, Takarazuka-shi (JP); Suguru Sakamoto, Makinohara-shi (JP); Kouhei Ootsuka, Takarazuka-shi (JP)

(21) Appl. No.: 18/830,589

(22) Filed: Sep. 11, 2024

(30) Foreign Application Priority Data
Sep. 21, 2023 (JP) 2023-154102

(51) Int. Cl. B60L 53/16; B60L 53/35

(52) U.S. Cl. CPC B60L 53/16; B60L 53/35

(57) ABSTRACT

A vehicle charging device includes a connector engaged with an inlet, a support member, a coupling mechanism that couples the connector with the support member, an arm that raises and lowers the support member by rotating, and a control unit. The control unit sets a rotational position of the support member to be a predetermined rotational position when causing a distal end of the connector to be opposed to an opening part of the inlet, and the predetermined rotational position is a rotational position where the distal end of the connector first abuts on the inlet when raising the support member, and an inclination angle of the connector coincides with an inclination angle of the inlet when the support member is raised to a target position.

### CROSS-REFERENCE TO RELATED APPLICATION(S)

The present application claims priority to and incorporates by reference the entire contents of Japanese Patent Application No. 2023-154102 filed in Japan on Sep. 21, 2023.

### BACKGROUND OF THE INVENTION

### 1. Field of the Invention

The present invention relates to a vehicle charging device.

### 2. Description of the Related Art

In the related art, there is known a charging device for charging vehicles. A charging system for vehicles in Japanese Patent Application Laid-open No. 2022-26379 includes a power supply device that includes a power supply engagement body, and is disposed in a vehicle stopping space. The charging system for vehicles includes an inserting and extracting direction movement part that engages the power supply engagement body with a power reception engagement body of the vehicle.

A vehicle and an inlet may be inclined depending on weight of an occupant or a load. There is a demand for a technique of appropriately positioning a connector with respect to the inlet even in a case in which the inlet is inclined.

### SUMMARY OF THE INVENTION

An object of the present invention is to provide a vehicle charging device that can appropriately position the connector with respect to the inlet.

In order to achieve the above mentioned object, a vehicle charging device according to one aspect of the present invention includes a connector that is engaged with an inlet disposed on a vehicle; a support member; a coupling mechanism that couples the connector with the support member, and allows the connector to change in attitude with respect to the support member; an arm that includes a first end part coupled with the support member and a second end part supported in a rotatable manner, and raises and lowers the support member by rotating; a driving mechanism that moves the support member, and rotates the support member; and a control unit, wherein the control unit performs angle control for causing an inclination angle of the connector to coincide with an inclination angle of the inlet at the time of causing a distal end of the connector to be opposed to an opening part of the inlet, the control unit sets a rotational position of the support member to be a predetermined rotational position in the angle control, and the predetermined rotational position is a rotational position where the distal end of the connector first abuts on the inlet at the time of raising the support member, and the inclination angle of the connector coincides with the inclination angle of the inlet in a case in which the support member is raised to a target position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a vehicle charging device according to an embodiment;

FIG. 2 is a perspective view of the vehicle charging device according to the embodiment;

FIG. 3 is a perspective view of the vehicle charging device according to the embodiment;

FIG. 4 is a side view of the vehicle charging device according to the embodiment;

FIG. 5 is a block diagram of the vehicle charging device according to the embodiment;

FIG. 6 is a side view of an inlet being scanned by a sensor;

FIG. 7 is a side view of the inlet being scanned by the sensor;

FIG. 8 is a bottom view of the inlet being scanned by the sensor;

FIG. 9 is a side view illustrating a pitch angle;

FIG. 10 is a bottom view of the inlet being scanned by the sensor;

FIG. 11 is a front view illustrating a roll angle;

FIG. 12 is a bottom view of the inlet according to the embodiment;

FIG. 13 is a cross-sectional view of the inlet and a connector;

FIG. 14 is a cross-sectional view of the inlet and the connector;

FIG. 15 is a diagram illustrating a configuration of a coupling mechanism according to the embodiment;

FIG. 16 is a diagram for explaining a predetermined rotational position in angle control;

FIG. 17 is a diagram illustrating the connector being in contact with the inlet;

FIG. 18 is a diagram illustrating the connector parallel to the inlet;

FIG. 19 is a diagram for explaining a predetermined rotational position in angle control;

FIG. 20 is a diagram illustrating the connector parallel to the inlet;

FIG. 21 is a diagram illustrating a gap generated between the connector and the inlet;

FIG. 22 is a diagram for explaining angle control according to a first modification of the embodiment; and

FIG. 23 is a diagram of a vehicle charging device according to a second modification of the embodiment.

### DETAILED DESCRIPTION OF THE PREFERRED EMBODIMENTS

The following describes a vehicle charging device according to an embodiment of the present invention in detail with reference to the drawings. The invention is not limited to the embodiment. Constituent elements in the following embodiment include a constituent element that is easily conceivable by those skilled in the art, or substantially the same constituent element.

### Embodiment

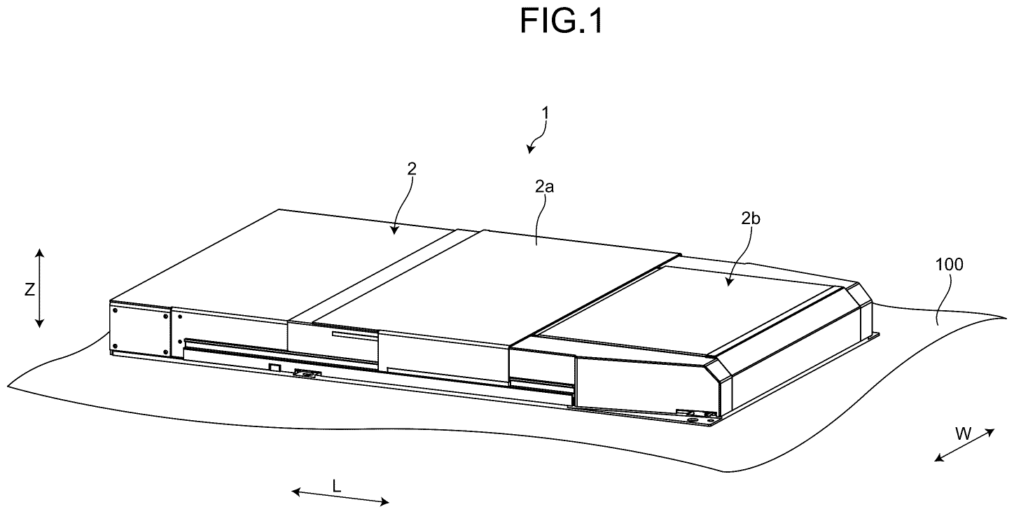

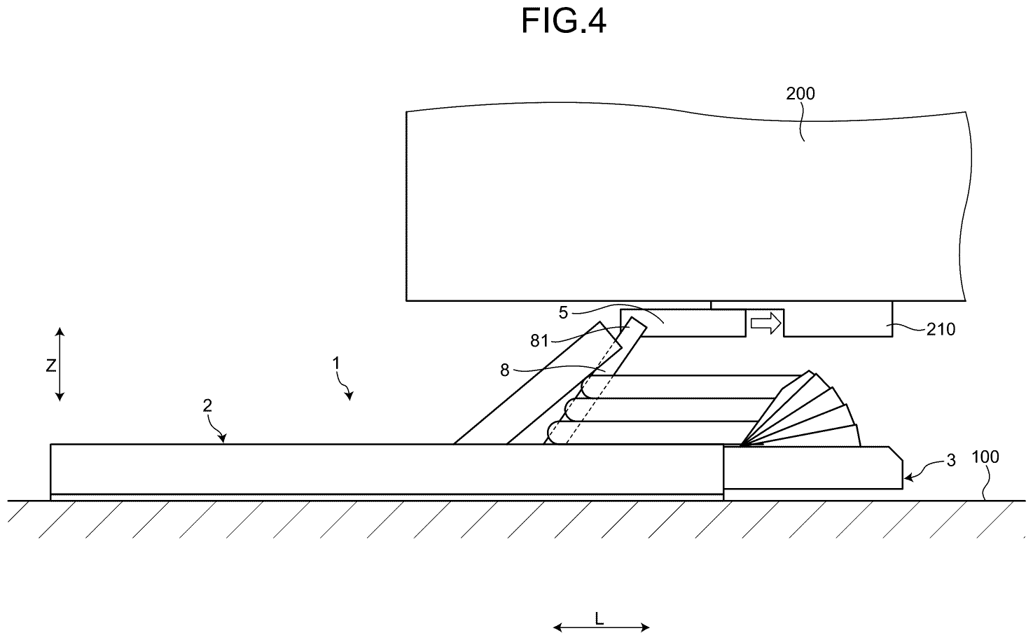

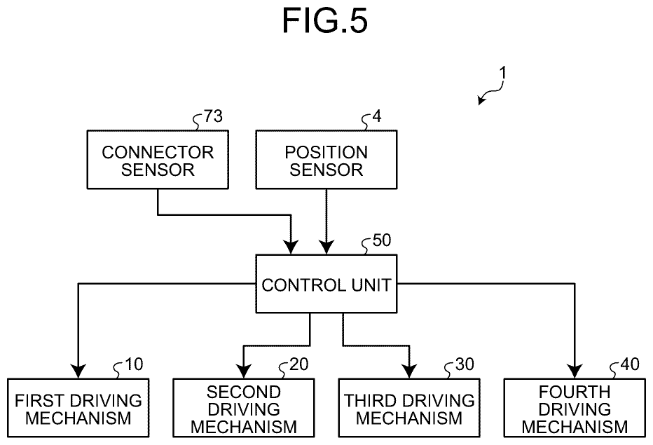

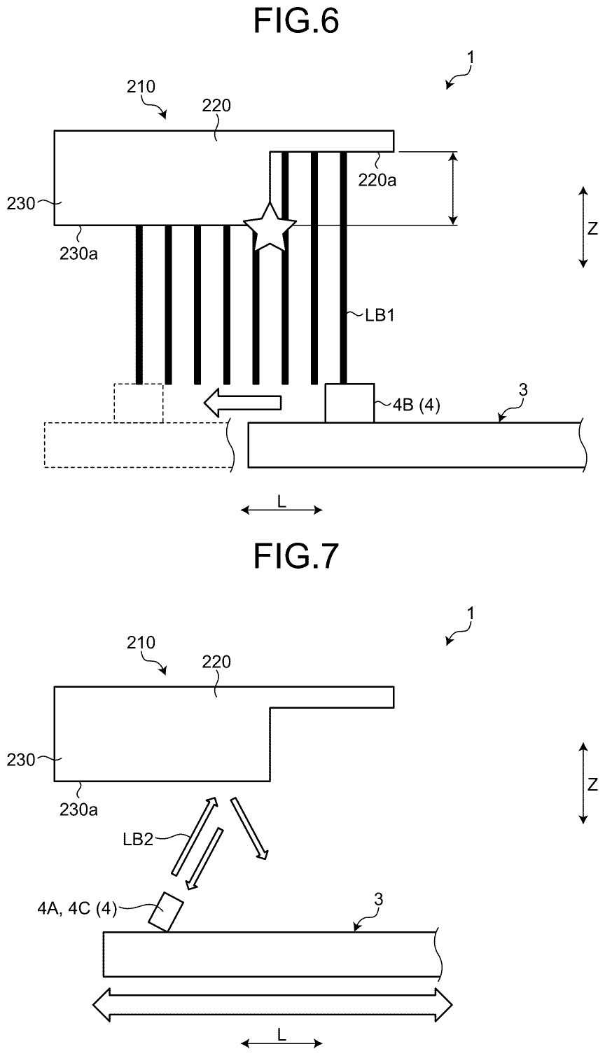

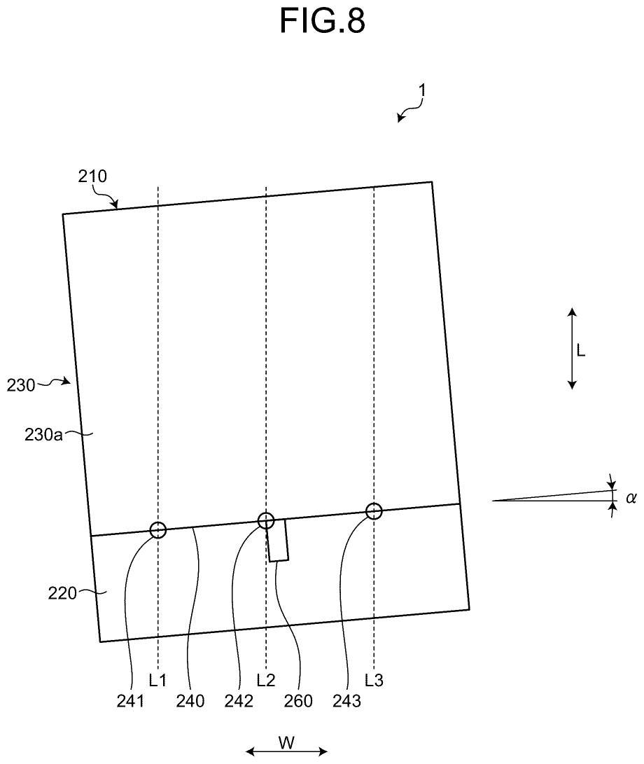

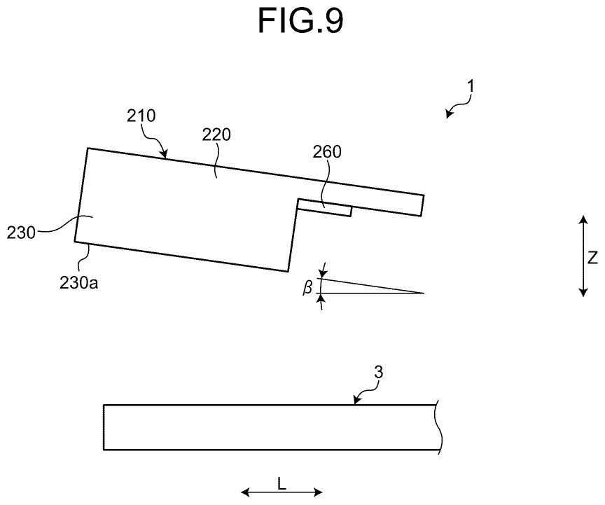

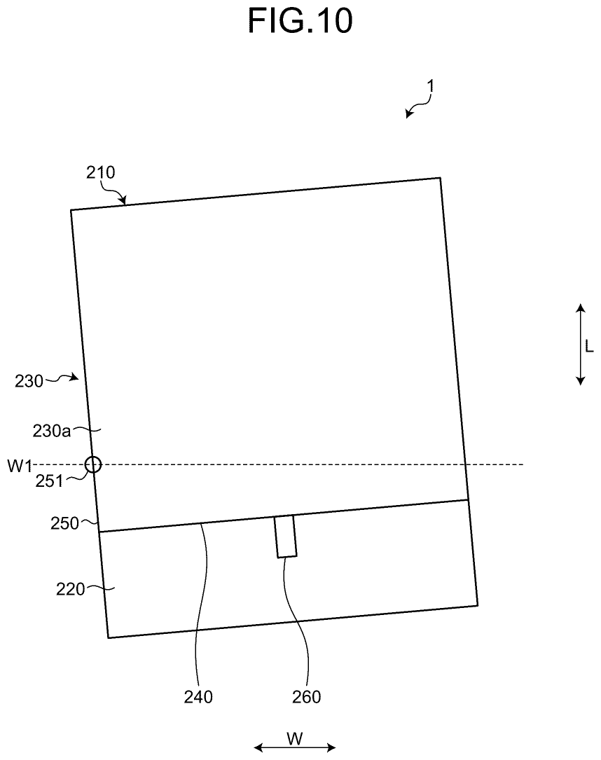

The following describes the embodiment with reference to FIG. 1 to FIG. 20. The present embodiment relates to a vehicle charging device. FIG. 1 to FIG. 3 are perspective views of the vehicle charging device according to the embodiment, FIG. 4 is a side view of the vehicle charging device according to the embodiment, FIG. 5 is a block diagram of the vehicle charging device according to the embodiment, FIG. 6 and FIG. 7 are side views of an inlet being scanned by a sensor, FIG. 8 is a bottom view of the inlet being scanned by the sensor, FIG. 9 is a side view illustrating a pitch angle, and FIG. 10 is a bottom view of the inlet being scanned by the sensor.

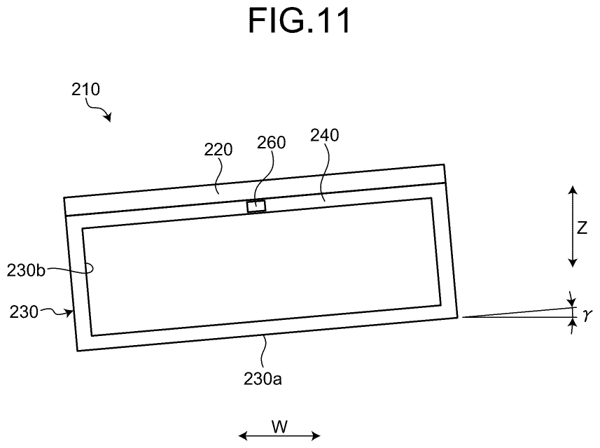

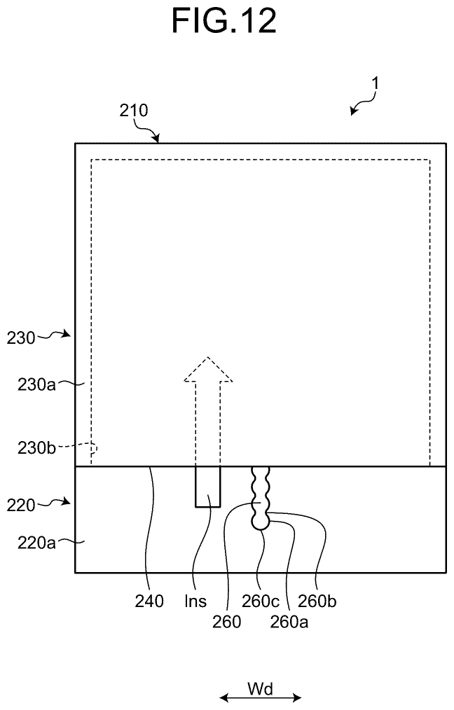

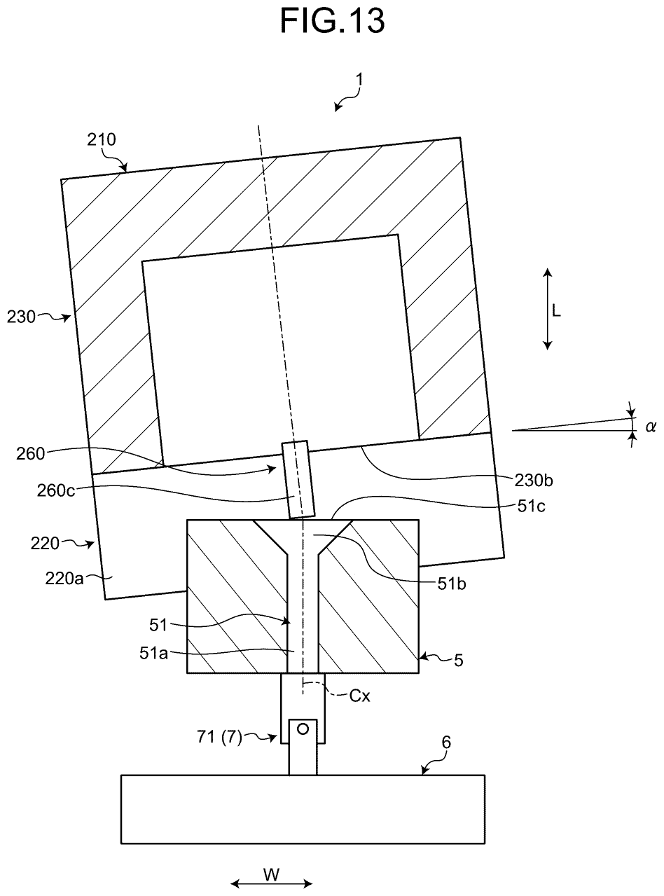

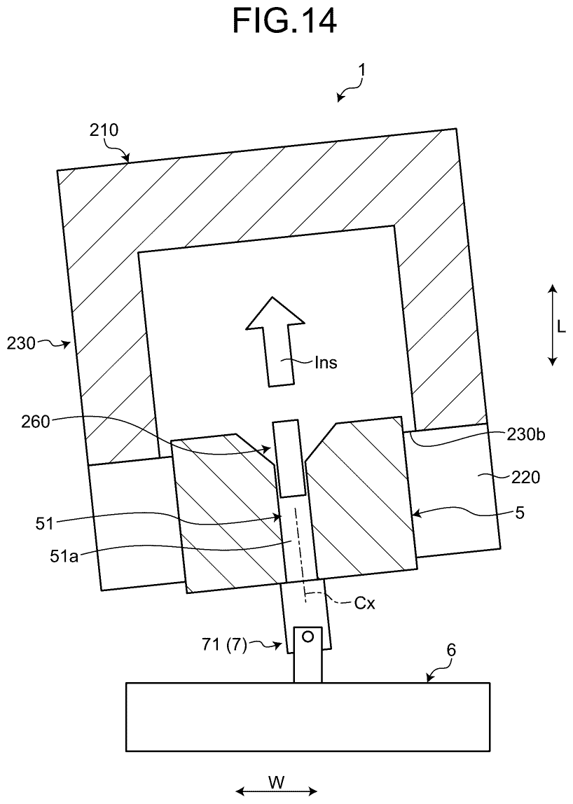

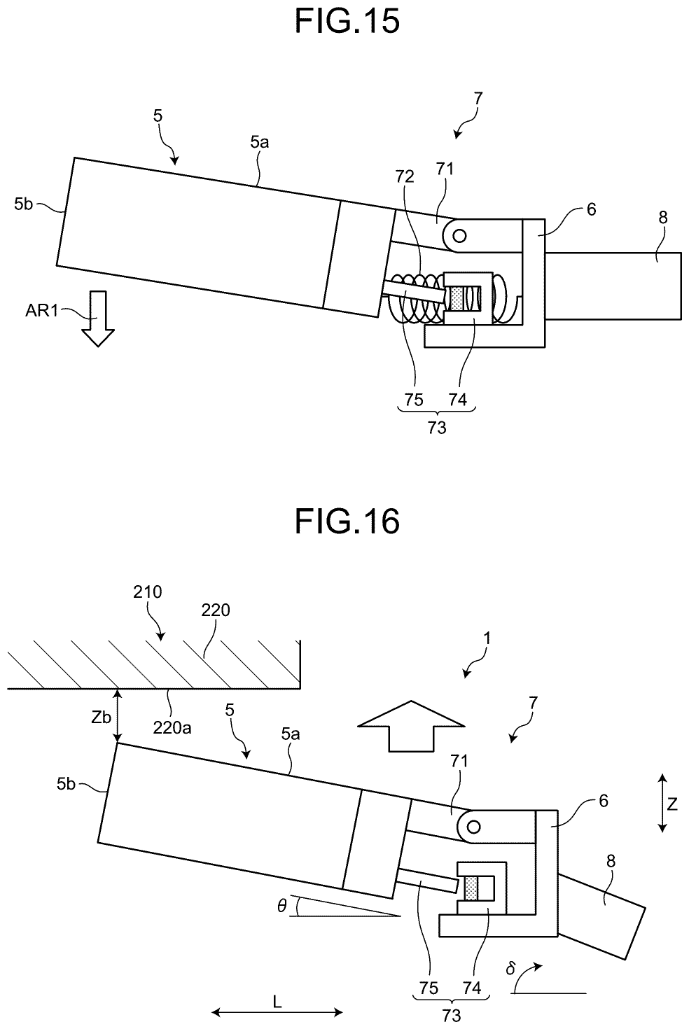

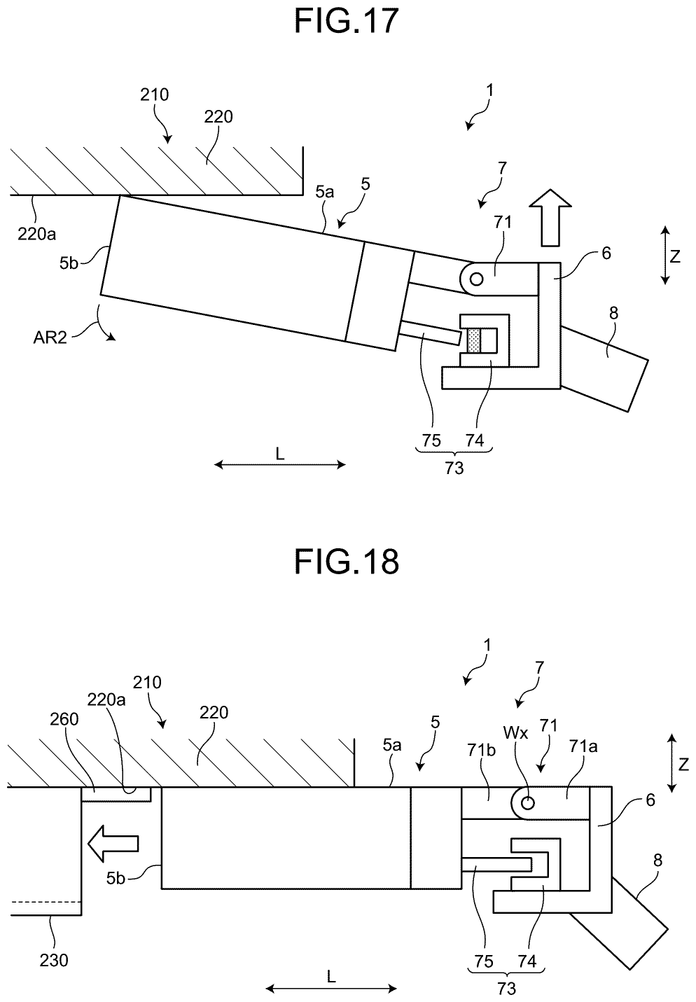

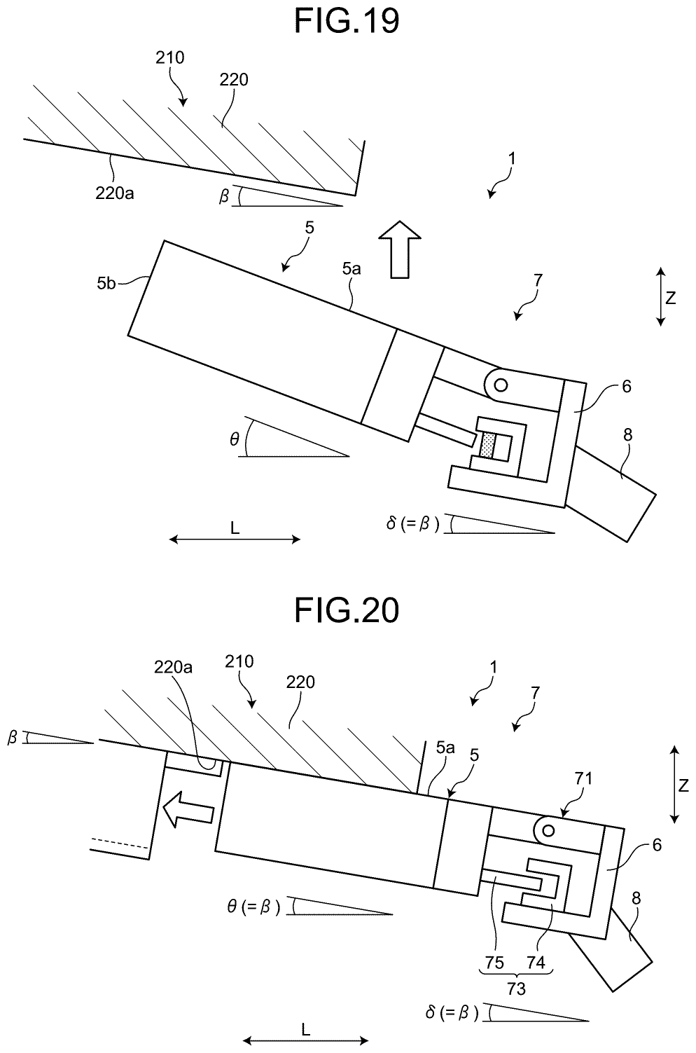

FIG. 11 is a front view illustrating a roll angle, FIG. 12 is a bottom view of the inlet according to the embodiment, FIG. 13 and FIG. 14 are cross-sectional views of the inlet and a connector, FIG. 15 is a diagram illustrating a configuration of a coupling mechanism according to the embodiment, FIG. 16 is a diagram for explaining a predetermined rotational position in angle control, FIG. 17 is a diagram illustrating the connector being in contact with the inlet, FIG. 18 is a diagram illustrating the connector parallel to the inlet, FIG. 19 is a diagram for explaining a predetermined rotational position in angle control, and FIG. 20 is a diagram illustrating the connector parallel to the inlet.

As illustrated in FIG. 1, a vehicle charging device 1 according to the present embodiment is disposed on a floor part 100 of a vehicle stopping space in which a vehicle is stopped. The vehicle charging device 1 includes a housing 2. The housing 2 is fixed to the floor part 100. The housing 2 includes a cover 2a of a sliding type, and a cover 2b of a rotating type. The covers 2a and 2b cover a device housed in an internal space of the housing 2 from an upper side.

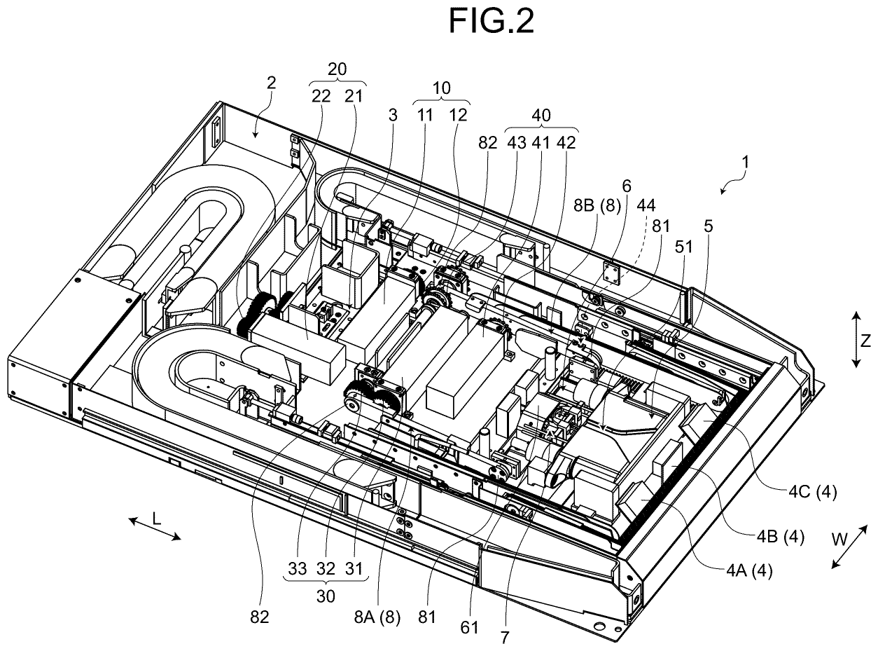

As illustrated in FIG. 2, the vehicle charging device 1 includes a slide body 3 disposed inside the housing 2. The slide body 3 is a plate-shaped base member, and can move in a first direction L and a second direction W with respect to the housing 2. The first direction L and the second direction W are horizontal directions. In a case in which a floor surface of the floor part 100 is inclined, the first direction L and the second direction W are preferably parallel to the floor surface of the floor part 100.

The first direction L corresponds to a vehicle longitudinal direction of a vehicle 200 as a charging target. The second direction W corresponds to a vehicle width direction of the vehicle 200. The vehicle 200 is positioned at a charging position where the vehicle 200 is charged by the vehicle charging device 1 while moving forward or backward along the first direction L. In the exemplified vehicle charging device 1, the first direction L is a longitudinal direction of the housing 2. The second direction W is a lateral direction of the housing 2, and orthogonal to the first direction L.

The vehicle charging device 1 includes a position sensor 4, a connector 5, a support member 6, a coupling mechanism 7, and an arm 8. The vehicle charging device 1 further includes a first driving mechanism 10, a second driving mechanism 20, a third driving mechanism 30, and a fourth driving mechanism 40.

As illustrated in FIG. 4, the connector 5 engages an inlet 210 disposed on the vehicle 200. The inlet 210 is disposed on a bottom part of the vehicle 200. By being engaged with the inlet 210, the connector 5 is connected to a battery of the vehicle 200.

The position sensor 4 is used for detecting the position of the inlet 210. The position sensor 4 may be a sensor for range finding, may be a sensor that takes an image to detect an object in the image, or may be another position detecting sensor. The position sensor 4 may include a plurality of sensors using different detection methods. The position sensor 4 according to the present embodiment is a laser sensor that detects a distance to a reflective object by laser light. The position sensor 4 emits laser light in a direction determined in advance, and receives the laser light reflected off an object.

The position sensor 4 is disposed on the slide body 3, and moves together with the slide body 3. The position sensor 4 exemplified in FIG. 2 includes a first sensor 4A, a second sensor 4B, and a third sensor 4C. The three sensors 4A, 4B, and 4C are arranged side by side in the second direction W in this order. The second sensor 4B emits laser light toward an upper side in an upper and lower direction Z. The upper and lower direction Z is a direction orthogonal to both of the first direction L and the second direction W, and corresponding to a vehicle upper and lower direction of the vehicle 200. The first sensor 4A and the third sensor 4C emit laser light in an oblique direction inclined with respect to the upper and lower direction Z.

The connector 5 is a charging connector that charges the battery of the vehicle 200. The connector 5 includes a terminal for charging. The vehicle charging device 1 according to the present embodiment is configured to be able to move the position of the connector 5 in the first direction L, the second direction W, and the upper and lower direction Z.

The first driving mechanism 10 is a mechanism for moving the connector 5 in the first direction L. The first driving mechanism 10 includes a first motor 11 and a gear wheel 12. The gear wheel 12 is disposed on an output shaft of the first motor 11, and meshes with a rack gear disposed on the slide body 3. The first motor 11 can move the connector 5 in the first direction L by normally rotating and reversely rotating.

The second driving mechanism 20 is a mechanism for moving the connector 5 in the second direction W. The second driving mechanism 20 includes a second motor 21 and a gear wheel 22. The gear wheel 22 is disposed on an output shaft of the second motor 21. The gear wheel 22 meshes with a rack gear disposed on the housing 2 via a reduction gear. The second motor 21 can move the slide body 3 in the second direction W by normally rotating and reversely rotating.

The third driving mechanism 30 is a mechanism for moving the connector 5 in the upper and lower direction Z. The connector 5 is coupled to the slide body 3 via the arm 8, the support member 6, and the coupling mechanism 7. The arm 8 is a plate-shaped member, and includes a first end part 81 and a second end part 82. The first end part 81 is coupled to the support member 6. The second end part 82 is supported by the slide body 3 in a rotatable manner. That is, the arm 8 can rotate about the second end part 82 as a rotation center. The arm 8 raises and lowers the support member 6 by rotating.

The vehicle charging device 1 according to the present embodiment includes a first arm 8A and a second arm 8B. The first arm 8A and the second arm 8B extend in the first direction L, and are opposed to each other in the second direction W. The second end parts 82 of the two arms 8A and 8B are connected to each other via a shaft. Thus, the two arms 8A and 8B rotate in conjunction with each other.

The support member 6 is coupled to the first end part 81 of the first arm 8A and the first end part 81 of the second arm 8B. The support member 6 is a plate-shaped member, and extends in the second direction W. The support member 6 is axially supported by the first end part 81 of the arm 8 to be able to rotate relatively to the arm 8.

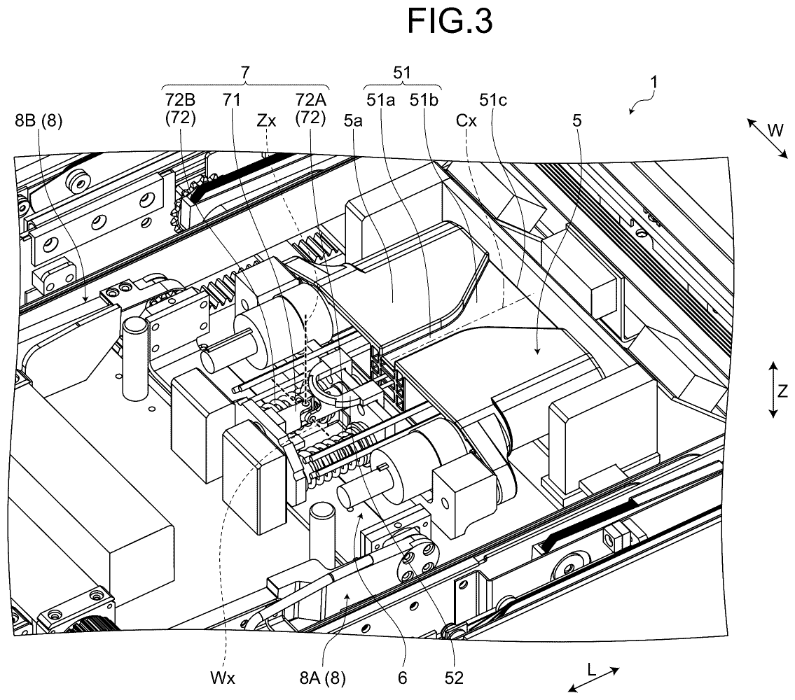

The coupling mechanism 7 couples the connector 5 to the support member 6, and is configured to allow the connector 5 to change in attitude with respect to the support member 6. As illustrated in FIG. 3, the coupling mechanism 7 includes a universal joint 71 and a spring 72. The universal joint 71 and the spring 72 are disposed between the support member 6 and the connector 5, and extend in the first direction L. One end of each of the universal joint 71 and the spring 72 is connected to the support member 6, and the other end of each of the universal joint 71 and the spring 72 is connected to the connector 5.

A bearing may be disposed between the universal joint 71 and the connector 5. In this case, the bearing allows the connector 5 to rotate about a center axis in the first direction L as a rotation center. In a case in which the bearing is disposed, the connector 5 can rotate relatively to the universal joint 71.

The universal joint 71 according to the present embodiment allows the connector 5 to change in attitude in two rotation directions. More specifically, the universal joint 71 allows the connector 5 to rotate about a center axis Wx in the second direction W as a rotation center. The universal joint 71 further allows the connector 5 to rotate about a center axis Zx in the upper and lower direction Z as a rotation center. The universal joint 71 is, for example, a cruciform joint.

The spring 72 includes a first spring 72A and a second spring 72B. The first spring 72A and the second spring 72B are disposed on both sides in the second direction W across the universal joint 71. The first spring 72A and the second spring 72B cause spring force, which returns the position of the connector 5 to a neutral position in the rotation direction, to act on the connector 5. In other words, the first spring 72A and the second spring 72B applies, to the connector 5, energizing force by which the connector 5 transitions to the attitude at the neutral position. For example, in a case in which the attitude of the connector 5 is changed by downward external force and a distal end of the connector 5 moves to a lower side than the neutral position, the spring 72 applies, to the connector 5, energizing force by which the distal end of the connector 5 is raised. Thus, in a case in which external force caused by contact with another member is not acting on the connector 5, the spring 72 can maintain the attitude of the connector 5 to be the attitude at the neutral position.

The third driving mechanism 30 moves the connector 5 in the upper and lower direction Z by rotating the arm 8. As illustrated in FIG. 2, the third driving mechanism 30 includes a third motor 31, a first gear wheel 32, and a second gear wheel 33. The first gear wheel 32 is disposed on an output shaft of the third motor 31. The second gear wheel 33 is connected to a shaft that couples the two arms 8A and 8B, and meshes with the first gear wheel 32. The third motor 31 causes the arm 8 to rotate by normally rotating and reversely rotating.

The fourth driving mechanism 40 is configured to change an angle θ of the connector 5. The angle θ is an inclination angle of the connector 5 with respect to the first direction L. The fourth driving mechanism 40 includes a fourth motor 41, a first sprocket 42, and a pair of second sprockets 43. The first sprocket 42 is disposed on an output shaft of the fourth motor 41. The second sprocket 43 is disposed coaxially with the shaft that couples the arms 8A and 8B, and rotates relatively to the shaft. An endless chain is wound around the first sprocket 42 and the second sprocket 43. A third sprocket 44 is disposed on the support member 6. An endless chain is wound around the second sprocket 43 and the third sprocket 44. The fourth motor 41 causes the support member 6 to rotate relatively to the arms 8A and 8B by normally rotating and reversely rotating. When the support member 6 rotates, the angle θ of the connector 5 is changed.

As illustrated in FIG. 2, a cover 61 is fixed to the support member 6. The cover 61 covers an end part of the coupling mechanism 7 on the support member 6 side. As illustrated in FIG. 3, a U-shaped abutting member 52 is fixed to the connector 5. The abutting member 52 abuts on the cover 61, and is supported by the cover 61. The cover 61 and the abutting member 52 regulate driving of the connector 5. This regulation structure transmits force in an engaging direction to the connector 5 while allowing the connector 5 to change in attitude when the connector 5 engages the inlet 210, for example.

As illustrated in FIG. 4, the vehicle charging device 1 engages the connector 5 with the inlet 210 of the vehicle 200. As described below, the vehicle charging device 1 detects the position of the inlet 210 and the attitude of the inlet 210 before engaging the connector 5 with the inlet 210. The vehicle charging device 1 engages the connector 5 with the inlet 210 while controlling the position of the connector 5 and the attitude of the connector 5 based on a detection result.

FIG. 5 illustrates a block diagram of the vehicle charging device 1 according to the present embodiment. As illustrated in FIG. 5, the vehicle charging device 1 includes a control unit 50. The control unit 50 controls the position sensor 4, and acquires a detection result of the position sensor 4. The control unit 50 also controls a connector sensor 73 (described later), and acquires a detection signal of the connector sensor 73. The control unit 50 also controls the first driving mechanism 10, the second driving mechanism 20, the third driving mechanism 30, and the fourth driving mechanism 40. The control unit 50 calculates the position of the inlet 210 and the attitude of the inlet 210 based on the detection result of the position sensor 4.

FIG. 6 illustrates a state in which the position sensor 4 scans the inlet 210 in the present embodiment. As illustrated in FIG. 6, the inlet 210 includes a base part 220 and an engagement part 230. The base part 220 is a portion fixed to the vehicle 200, and has a substantially flat-plate shape. The engagement part 230 bulges from the base part 220 toward a lower side in the upper and lower direction Z. The engagement part 230 has an opening part into which the connector 5 is inserted. A terminal is housed inside the engagement part 230. The engagement part 230 according to the present embodiment has a rectangular-parallelepiped shape.

A step in the upper and lower direction Z is present between a lower surface 220a of the base part 220 and a lower surface 230a of the engagement part 230. The control unit 50 calculates the position of the engagement part 230 and a position of a projection 260 (described later) based on this step. As illustrated in FIG. 6, the control unit 50 causes the position sensor 4 to emit laser light LB while moving the slide body 3 in the first direction L. For example, the position sensor 4 emits the laser light LB at respective positions at regular intervals along the first direction L to measure a distance to an object. FIG. 6 illustrates laser light LB1 emitted from the second sensor 4B. An emitting direction of the laser light LB1 by the second sensor 4B is the upper and lower direction Z.

FIG. 7 illustrates laser light LB2 emitted from the first sensor 4A and the third sensor 4C. The laser light LB2 is emitted in a direction inclined with respect to the upper and lower direction Z. Part of the laser light LB2 is reflected off the inlet 210 toward the first sensor 4A and the third sensor 4C. The other part of the laser light LB2 is reflected in a direction different from the position sensor 4.

The vehicle charging device 1 according to the present embodiment includes the first sensor 4A, the second sensor 4B, and the third sensor 4C. Due to this, as illustrated in FIG. 8, the inlet 210 can be scanned along three lines L1, L2, and L3 at different positions in the second direction W. The three lines L1, L2, and L3 are arranged at regular intervals, for example.

The control unit 50 detects a position of an end part 240 based on the detection result of the position sensor 4. The end part 240 is an end part of the engagement part 230 in the first direction L. As illustrated in FIG. 11, the end part 240 has an opening part 230b into which the connector 5 is inserted. The control unit 50 determines, to be the end part 240, a point where a distance detected by the position sensor 4 largely changes.

As illustrated in FIG. 8, a position 241 of the end part 240 intersecting with a first line L1, a position 242 of the end part 240 intersecting with a second line L2, and a position 243 of the end part 240 intersecting with a third line L3 are acquired. The control unit 50 calculates coordinate values of the positions 241, 242, and 243 in the respective directions L, W, and Z, for example. The control unit 50 calculates a yaw angle α of the inlet 210 based on the coordinate values of the positions 241, 242, and 243. The yaw angle α is a rotation angle of the vehicle 200 and the inlet 210 about a line in the upper and lower direction Z as a rotation center. The yaw angle α is also an inclination angle of the end part 240 with respect to the second direction W.

The control unit 50 also calculates a pitch angle β of the inlet 210 based on the detection result of the position sensor 4. As illustrated in FIG. 9, the pitch angle β is an inclination angle of the inlet 210 with respect to the first direction L. The pitch angle β is also a rotation angle of the vehicle 200 and the inlet 210 about a line in the second direction W as a rotation center.

FIG. 10 illustrates a line W1 to be scanned along the second direction W. The control unit 50 scans the inlet 210 by the position sensor 4 along the line W1. The position of the line W1 in the first direction L is set based on the detected positions 241, 242, and 243, for example. The line W1 is set to intersect with the engagement part 230. The control unit 50 causes the position sensor 4 to scan the inlet 210 while moving the slide body 3 in the second direction W.

The control unit 50 calculates an end part 250 of the inlet 210 based on a scanning result along the line W1. The end part 250 is an end part of the engagement part 230 in the second direction W. At the end part 250, a step is present between the lower surface 230a and the base part 220. The control unit 50 determines, to be the end part 250, a point where a distance detected by the position sensor 4 largely changes. The control unit 50 acquires a position 251 at which the end part 250 intersects with the line W1. The control unit 50 calculates coordinate values of the position 251 in the respective directions L, W, and Z, for example.

The control unit 50 also calculates a roll angle γ of the inlet 210 based on the detection result of the position sensor 4 along the line W1. As illustrated in FIG. 11, the roll angle γ is an inclination angle of the inlet 210 with respect to the second direction W. The roll angle γ is also a rotation angle of the vehicle 200 and the inlet 210 about a line in the first direction L as a rotation center. As illustrated in FIG. 12, a linear projection 260 is disposed on the inlet 210. The projection 260 extends along an insertion direction Ins in which the connector 5 is inserted into the inlet 210. The insertion direction Ins is, for example, the vehicle longitudinal direction of the vehicle 200. The insertion direction Ins is also an axial direction of the engagement part 230. The opening part 230b opens in the insertion direction Ins. The projection 260 bulges from the lower surface 220a of the base part 220 toward a lower side. The projection 260 extends from the end part 240 of the engagement part 230 in a direction away from the engagement part 230.

The projection 260 according to the present embodiment has an uneven shape in which a protruding part 260a and a recessed part 260b are alternately arranged along the insertion direction Ins. The protruding part 260a projects toward both sides in a width direction Wd. The width direction Wd is a direction orthogonal to the insertion direction Ins, and corresponds to the second direction W. For example, the width direction Wd is the vehicle width direction of the vehicle 200.

As illustrated in FIG. 3, for example, the connector 5 includes a groove part 51 to be guided by the projection 260. The groove part 51 is disposed on a top surface 5a of the connector 5. The top surface 5a is a surface opposed to the inlet 210 in the upper and lower direction Z. The connector 5 is engaged with the engagement part 230 while the top surface 5a is slid on the lower surface 220a of the inlet 210.

The groove part 51 includes a first groove part 51a linearly extending along the first direction L, and a second groove part 51b having a tapered shape. A size of a width of the first groove part 51a corresponds to a size of a width of the projection 260. When the projection 260 is inserted into the first groove part 51a, the connector 5 is guided to the opening part 230b of the engagement part 230 along the insertion direction Ins.

The second groove part 51b is continuous to the first groove part 51a, and has a tapered shape the width of which is reduced as being closer to the first groove part 51a along the first direction L. The second groove part 51b is disposed on a distal end side in the insertion direction Ins with respect to the first groove part 51a. The second groove part 51b guides a distal end 260c of the projection 260 into the first groove part 51a. A spread angle of the second groove part 51b is determined depending on a permissible maximum value of the yaw angle α of the inlet 210. That is, the second groove part 51b is configured to be able to house the projection 260 and guide the projection 260 to the first groove part 51a even in a case in which the yaw angle α is a set maximum value.

The second groove part 51b includes an entrance part 51c opening in the first direction L. The width of the second groove part 51b is maximum at the entrance part 51c. The groove part 51 has a center axis Cx. In a case in which the coupling mechanism 7 is in a neutral state, the center axis Cx extends in the first direction L.

The control unit 50 calculates coordinate values of the projection 260 based on the coordinate values of the positions 241, 242, and 243 of the engagement part 230, the coordinate values of the position 251, the pitch angle β of the inlet 210, and the like. The control unit 50 calculates a position of the distal end 260c of the projection 260, for example. The control unit 50 calculates a target position and a target angle of the connector 5 based on the coordinate values of the projection 260.

The target position of the connector 5 is, for example, a target position in each of the first direction L, the second direction W, and the upper and lower direction Z. The target position of the connector 5 may be a target position of a predetermined part of the connector 5. The predetermined part of the connector 5 is, for example, a position of the center axis Cx of the second groove part 51b. The predetermined part may be a portion where the entrance part 51c intersects with the center axis Cx.

The position of the connector 5 in the first direction L is controlled by the first driving mechanism 10. The position of the connector 5 in the second direction W is controlled by the second driving mechanism 20. The position of the connector 5 in the upper and lower direction Z is controlled by the third driving mechanism 30 and the fourth driving mechanism 40.

The target angle of the connector 5 is a target value of the angle θ of the connector 5. The target angle of the connector 5 is determined so that the top surface 5a of the connector 5 can be brought into surface contact with the lower surface 220a of the inlet 210. The angle θ of the connector 5 is controlled by the fourth driving mechanism 40.

The control unit 50 sets a command value for each of the first driving mechanism 10, the second driving mechanism 20, the third driving mechanism 30, and the fourth driving mechanism 40 based on the target position and the target angle of the connector 5. The first motor 11 of the first driving mechanism 10 is rotated by a driving signal corresponding to the command value, and moves the slide body 3 to the target position in the first direction L. The second motor 21 of the second driving mechanism 20 is rotated by a driving signal corresponding to the command value, and moves the slide body 3 to the target position in the second direction W.

The third motor 31 of the third driving mechanism 30 is rotated by a driving signal corresponding to the command value, and moves the support member 6 to the target position in the upper and lower direction Z. The fourth motor 41 of the fourth driving mechanism 40 is rotated by a driving signal corresponding to the command value, and causes the angle θ of the connector 5 to be the target angle.

The control unit 50 according to the present embodiment performs positioning control and engagement control at the time of engaging the connector 5 with the inlet 210. The positioning control is control for positioning the distal end of the connector 5 at a position opposed to the opening part 230b of the inlet 210. The engagement control is control that is performed after the positioning control, and is control for engaging the connector 5 with the engagement part 230 of the inlet 210.

FIG. 13 illustrates the connector 5 positioned at the position opposed to the opening part 230b of the inlet 210. The inlet 210 illustrated in FIG. 13 has the yaw angle α, and is inclined with respect to the first direction L and the second direction W. The entrance part 51c of the groove part 51 is positioned at the distal end 260c of the projection 260. The entrance part 51c is opposed to the projection 260 in the first direction L. The entrance part 51c is also opposed to the opening part 230b of the engagement part 230. The connector 5 is positioned so that the center axis Cx of the groove part 51 intersects with the center axis of the projection 260 at the entrance part 51c. In FIG. 13, the connector 5 is in contact with the lower surface 220a of the base part 220. That is, the angle θ of the connector 5 coincides with the pitch angle β of the inlet 210.

The control unit 50 performs the engagement control from the state illustrated in FIG. 13, and moves the connector 5 in the first direction L toward the engagement part 230. The projection 260 enters the second groove part 51b of the connector 5. When the connector 5 further moves toward the engagement part 230, as illustrated in FIG. 14, the projection 260 is guided into the first groove part 51a. The projection 260 guides the groove part 51 to change the attitude of the connector 5. More specifically, the projection 260 causes the connector 5 to rotate to cause the direction of the center axis Cx of the groove part 51 to coincide with the insertion direction Ins. The vehicle charging device 1 according to the present embodiment allows the connector 5 to rotate by the universal joint 71 of the coupling mechanism 7. The connector 5 is inserted into the opening part 230b of the engagement part 230 while being guided by the projection 260.

To cause the connector 5 to be appropriately guided by the projection 260, it is preferable that the top surface 5a of the connector 5 is brought into contact with the lower surface 220a of the inlet 210, and the inclination angle of the inlet 210 is equal to the inclination angle of the connector 5. As described below, the vehicle charging device 1 according to the present embodiment performs the angle control for causing the inclination angle of the connector 5 to coincide with the inclination angle of the inlet 210. The angle control is part of the positioning control, and performed by the control unit 50.

First, the following describes the connector sensor 73 of the coupling mechanism 7. As illustrated in FIG. 15, the coupling mechanism 7 according to the present embodiment includes the connector sensor 73. The connector sensor 73 is a sensor that outputs a detection signal in a case in which a distal end 5b of the connector 5 is lowered to a predetermined position determined in advance with respect to the support member 6. The exemplified connector sensor 73 includes a photosensor 74 and a shielding plate 75. The photosensor 74 is disposed on the support member 6. The photosensor 74 includes a light source and a light receiving part that detects light from the light source.

The shielding plate 75 is a plate member having a light shielding property disposed on the connector 5. FIG. 15 illustrates the connector 5 at an initial position. The initial position is a relative position of the connector 5 with respect to the support member 6, and is the position of the connector 5 in a case in which the connector 5 is not subjected to external force from another member. The spring 72 applies, to the connector 5, energizing force by which the connector 5 transitions to the attitude at the initial position. For example, in a case in which the connector 5 is brought into contact with the inlet 210 and the attitude of the connector 5 is deviated from the initial position, the spring 72 applies, to the connector 5, energizing force by which the connector 5 transitions to the attitude at the initial position.

The shielding plate 75 is configured not to block light of the photosensor 74 in a case in which the connector 5 is present at the initial position. When the connector 5 abuts on the inlet 210 at the time when the connector 5 is raised in the positioning control, the connector 5 receives downward force from the inlet 210. As indicated by an arrow AR1 in FIG. 15, when the distal end 5b of the connector 5 is lowered relatively to the support member 6, the shielding plate 75 is inserted into the photosensor 74, and the shielding plate 75 blocks light of the photosensor 74. In a case in which an amount of received light received by the light receiving part of the photosensor 74 is smaller than a threshold, the connector sensor 73 outputs a detection signal. The detection signal is a signal indicating that the distal end 5b of the connector 5 has been lowered to the predetermined position with respect to the support member 6.

FIG. 16 illustrates the attitude of the connector 5 at the time when the vehicle charging device 1 raises the connector 5 toward the inlet 210. The control unit 50 sets, to be a predetermined rotational position, a rotational position of the support member 6 at the time when the connector 5 is raised toward the inlet 210 in the angle control. The rotational position of the support member 6 is, for example, a rotational position based on the first direction L or the upper and lower direction Z. In a case in which it is based on the first direction L, the rotational position of the support member 6 is indicated by an angle δ illustrated in FIG. 16, for example. The predetermined rotational position is determined so that the distal end 5b of the connector 5 first abuts on the inlet 210 when the support member 6 is raised.

FIG. 16 illustrates the attitude of the connector 5 when the rotational position of the support member 6 is the predetermined rotational position. In this case, a distance Zb from the distal end 5b of the connector 5 to the lower surface 220a of the inlet 210 becomes the shortest distance between the top surface 5a and the lower surface 220a. In FIG. 16, the lower surface 220a of the base part 220 is parallel to the first direction L. In this case, the angle δ of the support member 6 may be 0°. The angle θ of the connector 5 at the initial position is an angle of elevation, and the connector 5 is inclined toward an upper side in the upper and lower direction Z as being closer to the distal end 5b.

The control unit 50 raises the connector 5 while maintaining the rotational position of the support member 6 at the predetermined rotational position. The third driving mechanism 30 rotates the arm 8 to raise the support member 6. The fourth driving mechanism 40 causes the support member 6 to rotate relatively to the arm 8 so that the rotational position of the support member 6 becomes the predetermined rotational position. Thus, the connector 5 is raised toward the lower surface 220a while maintaining the same angle θ.

FIG. 17 illustrates the connector 5 that starts to be brought into contact with the lower surface 220a of the base part 220. As illustrated in FIG. 17, the distal end 5b of the connector 5 is brought into contact with the lower surface 220a first. At this time, the connector sensor 73 is not outputting a detection signal. When the support member 6 is further raised, the connector 5 rotates as indicated by an arrow AR2. That is, the connector 5 rotates to lower the distal end 5b with respect to the support member 6.

FIG. 18 illustrates a state in which the support member 6 has been raised to the target position. The target position of the support member 6 is a position in the upper and lower direction Z, and is a position where the inclination angle of the connector 5 can coincide with the inclination angle of the inlet 210. The target position of the support member 6 is set while considering dimensions and the like of the coupling mechanism 7 based on the position, the pitch angle β, the roll angle γ, and the like of the inlet 210 that have been calculated.

As illustrated in FIG. 18, when the support member 6 is raised to the target position, the angle θ of the connector with respect to the first direction L coincides with the inclination angle of the inlet 210. In a case in which the lower surface 220a of the base part 220 is parallel to the first direction L, the top surface 5a of the connector 5 also becomes parallel with the first direction L. When the angle θ of the connector 5 is equal to the inclination angle of the inlet 210, the shielding plate 75 of the connector sensor 73 is inserted into the photosensor 74 to block light from the light source. Due to this, the connector sensor 73 outputs the detection signal. That is, in a case in which the connector 5 is appropriately positioned with respect to the inlet 210, the connector sensor 73 outputs the detection signal when the support member 6 is raised to the target position.

In the example of FIG. 18, the pitch angle β of the inlet 210 is 0°, and the angle δ of the support member 6 is also 0°. In this case, the connector sensor 73 outputs the detection signal when the distal end 5b of the connector 5 is lowered to a position where the angle θ of the connector 5 becomes 0°. At this point, a first shaft 71a and a second shaft 71b of the universal joint 71 have a linear shape when viewed from the second direction W. That is, the two shafts 71a and 71b are at neutral positions in a rotation direction about the center axis Wx in the second direction W as a rotation center. Thus, the connector sensor 73 can accurately output the detection signal without being affected by rotation about the center axis Zx in the upper and lower direction Z as a rotation center.

As illustrated in FIG. 18, when the connector sensor 73 outputs the detection signal, the top surface 5a of the connector 5 is in contact with the lower surface 220a of the base part 220, and parallel to the lower surface 220a. Thus, by moving the connector 5 toward the engagement part 230 from this state, the connector 5 is appropriately guided by the projection 260 of the inlet 210. Accordingly, the connector 5 can be smoothly engaged with the engagement part 230.

In a case in which the connector sensor 73 outputs the detection signal at a position different from the target position, and a case in which the connector sensor 73 does not output the detection signal even if the support member 6 is raised to the target position, the control unit 50 ends the positioning control and prohibits the engagement control.

For example, it is assumed that, after the position of the inlet 210 is calculated, an actual position of the inlet 210 becomes a position lower than the calculated position due to getting on and off of an occupant. In this case, the connector sensor 73 outputs the detection signal before the support member 6 is raised to the target position. For example, in a case in which the top surface 5a of the connector 5 has been brought into contact with the projection 260 of the inlet 210, the connector sensor 73 outputs the detection signal before the support member 6 is raised to the target position. In such a case, the control unit 50 interrupts the engagement control.

For example, it is assumed that, after the position of the inlet 210 is calculated, the actual position of the inlet 210 becomes a position higher than the calculated position due to getting on and off of an occupant. In this case, even if the support member 6 is raised to the target position, the connector sensor 73 does not output the detection signal in some cases. In a case in which an output timing for the detection signal is too early, or a case in which the detection signal is not output, the control unit 50 prohibits the engagement control assuming that the positioning control has failed. In a case in which the positioning control has failed, the control unit 50 may output voice or light to notify that the control is interrupted, or may display a message to notify that the control is interrupted on a display screen included in the vehicle charging device 1.

FIG. 19 is a diagram for explaining the angle control in a case in which the inlet 210 has the pitch angle β. The inlet 210 illustrated in FIG. 19 has the pitch angle β, and is inclined with respect to the first direction L. The control unit 50 sets the rotational position of the support member 6 so that the distal end 5b of the connector 5 first abuts on the inlet 210 when the support member 6 is raised. The control unit 50 sets the angle δ indicating the rotational position of the support member 6 to be the same angle as the pitch angle β of the inlet 210, for example.

When the support member 6 is raised from the state illustrated in FIG. 19, the distal end 5b of the connector 5 abuts on the lower surface 220a of the base part 220. When the support member 6 is raised to the target position, as illustrated in FIG. 20, the top surface 5a of the connector 5 becomes parallel with the lower surface 220a of the base part 220, and the connector sensor 73 outputs the detection signal. At this point, the angle θ of the connector 5 is equal to the pitch angle β of the inlet 210.

In this way, even if the inlet 210 is inclined, the vehicle charging device 1 according to the present embodiment can bring the top surface 5a of the connector 5 into contact with the lower surface 220a of the inlet 210. Accordingly, the vehicle charging device 1 according to the present embodiment can appropriately engage the connector 5 with the inlet 210.

As described above, the vehicle charging device 1 according to the present embodiment includes the connector 5, the support member 6, the coupling mechanism 7, the arm 8, the driving mechanism, and the control unit 50. The connector 5 is engaged with the inlet 210 disposed on the vehicle 200. The coupling mechanism 7 couples the connector 5 with the support member 6, and allows the connector 5 to change in attitude with respect to the support member 6. The arm 8 includes the first end part 81 coupled to the support member 6 and the second end part 82 supported in a rotatable manner, and raises and lowers the support member 6 by rotating.

The driving mechanism is a mechanism that moves the support member 6 and rotates the support member 6. The driving mechanism is, for example, constituted of the first driving mechanism 10, the second driving mechanism 20, the third driving mechanism 30, and the fourth driving mechanism 40. The first driving mechanism 10 moves the arm 8 in the first direction L in the horizontal direction. The second driving mechanism 20 moves the arm 8 in the second direction W in the horizontal direction. The third driving mechanism 30 rotates the arm 8. The fourth driving mechanism 40 rotates the support member 6 to change the angle θ of the connector 5 with respect to the first direction L.

The control unit 50 performs the angle control for causing the inclination angle of the connector 5 to coincide with the inclination angle of the inlet 210 when the distal end 5b of the connector 5 is caused to be opposed to the opening part 230b of the inlet 210. The inclination angle of the inlet 210 is, for example, the pitch angle β or the roll angle γ. The inclination angle of the connector 5 is, for example, the inclination angle with respect to the first direction L or the inclination angle with respect to the second direction W.

The control unit 50 sets the rotational position of the support member 6 to be the predetermined rotational position in the angle control. The predetermined rotational position is a rotational position where the distal end 5b of the connector 5 first abuts on the inlet 210 at the time of raising the support member 6. The predetermined rotational position is also a rotational position where the inclination angle of the connector 5 coincides with the inclination angle of the inlet 210 in a case in which the support member 6 is raised to the target position. The vehicle charging device 1 according to the present embodiment can cause the connector 5 to have the attitude matching the inclination of the inlet 210 by raising the connector 5 while pressing the distal end 5b of the connector 5 against the inlet 210. Accordingly, the vehicle charging device 1 according to the present embodiment can appropriately position the connector 5 with respect to the inlet 210. The control unit 50 may acquire the inclination angle of the inlet 210 by a sensor such as the position sensor 4, or may acquire it from the outside.

The vehicle charging device 1 according to the present embodiment includes the position sensor 4 that detects the inlet 210, and the connector sensor 73. The connector sensor 73 outputs the detection signal in a case in which the distal end 5b of the connector 5 is lowered to the predetermined position determined in advance with respect to the support member 6. The driving mechanism includes the first driving mechanism 10, the second driving mechanism 20, the third driving mechanism 30, and the fourth driving mechanism 40. The control unit 50 acquires the inclination angle of the inlet 210 with respect to the first direction L from the detection result of the position sensor 4. The predetermined rotational position is a rotational position where the connector sensor 73 outputs the detection signal in a case in which the support member 6 is raised to the target position. The vehicle charging device 1 according to the present embodiment can appropriately determine whether the inclination angle of the connector 5 coincides with the inclination angle of the inlet 210 based on an output from the connector sensor 73.

The coupling mechanism 7 according to the present embodiment includes the spring 72 that applies, to the connector 5, energizing force by which the connector 5 transitions to the attitude at the initial position. The predetermined position described above where the connector sensor 73 outputs the detection signal is a position lower than the position of the distal end 5b of the connector 5 when the connector 5 is in the attitude at the initial position. Due to this, in a case in which the distal end 5b of the connector 5 is lowered due to downward external force, it is possible to cause the connector sensor 73 to output the detection signal.

The control unit 50 according to the present embodiment prohibits the engagement control for the connector 5 with respect to the inlet 210 in a case in which the connector sensor 73 outputs the detection signal before the support member 6 is raised to the target position, or a case in which the connector sensor 73 does not output the detection signal even when the support member 6 is raised to the target position. Due to this, occurrence of failure in the engagement control can be prevented in advance.

The connector sensor 73 is not limited to a combination of the photosensor 74 and the shielding plate 75. The connector sensor 73 may be, for example, a proximity sensor, a limit switch, or other sensors.

In the vehicle charging device 1, the number, arrangement, and the angle of the position sensor 4 are not limited to the number, the arrangement, and the angle exemplified above. For example, the vehicle charging device 1 can acquire the position of the projection 260, and the yaw angle α, the roll angle γ, and the pitch angle β of the inlet 210 by at least one position sensor 4.

### First Modification of Embodiment

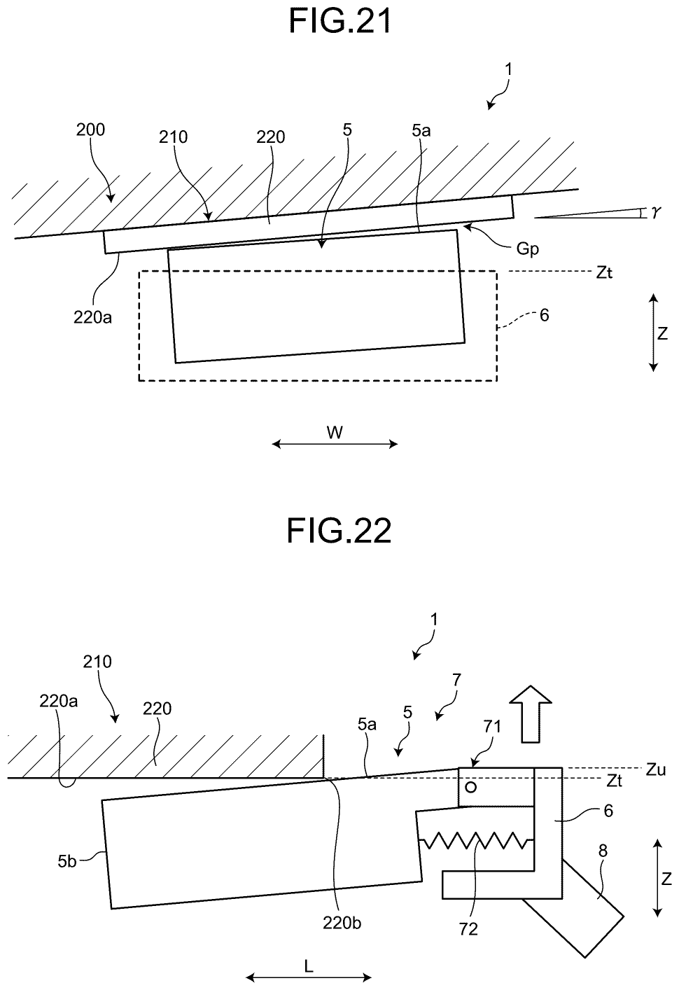

The following describes a first modification of the embodiment. FIG. 21 is a diagram illustrating a gap generated between the connector and the inlet, and FIG. 22 is a diagram for explaining angle control according to the first modification of the embodiment. The first modification of the embodiment is different from the embodiment described above in that the support member 6 is moved to an upper side than the target position in the angle control, for example.

FIG. 21 illustrates the support member 6 and the connector 5 at the time when the support member 6 is raised to a target position Zt in the upper and lower direction Z. The inlet 210 in FIG. 21 has the roll angle γ, and is inclined with respect to the second direction W. In a case in which the inlet 210 has the roll angle γ, the connector 5 is required to rotate relatively to the support member 6 against energizing force of the spring 72 to cause the inclination angle of the connector 5 with respect to the second direction W to be equal to the roll angle γ of the inlet 210. If a rotation amount of the connector 5 is insufficient at the time when the support member 6 is raised to the target position Zt, a gap Gp may be generated between the lower surface 220a of the inlet 210 and the connector 5.

In a case in which the gap Gp is not large, the connector sensor 73 outputs the detection signal in the vicinity of the target position Zt. At the time when the connector sensor 73 outputs the detection signal, a deviation between the position of the support member 6 and the target position Zt may fall within a range of an allowable error. In such a case, it is preferable to eliminate the gap Gp before engaging the connector 5 with the inlet 210.

The control unit 50 according to the first modification tries to eliminate the gap Gp by raising the support member 6 to the upper side than the target position Zt. As illustrated in FIG. 22, after raising the support member 6 to an upper position Zu than the target position Zt once, the control unit 50 lowers the support member 6 to the target position Zt. When the support member 6 is raised to the position Zu, the connector 5 rotates about an end part 220b of the base part 220 as a fulcrum. This rotation is rotation for lowering the distal end 5b of the connector 5 with respect to the support member 6. At this point, the top surface 5a of the connector 5 is pressed against the end part 220b. Thus, moment in a direction for reducing the gap Gp acts on the connector 5, and the gap Gp is eliminated.

The control unit 50 lowers the support member 6 from the position Zu to the target position Zt. At this point, the spring 72 of the coupling mechanism 7 applies, to the connector 5, energizing force for pressing the top surface 5a against the lower surface 220a of the base part 220. Accordingly, the vehicle charging device 1 can bring the top surface 5a into contact with the lower surface 220a in a state in which the gap Gp is eliminated when the support member 6 is lowered to the target position Zt. Due to this, a degree of parallelization of the top surface 5a of the connector 5 with respect to the lower surface 220a is improved, and the connector 5 can be appropriately engaged with the inlet 210.

### Second Modification of Embodiment

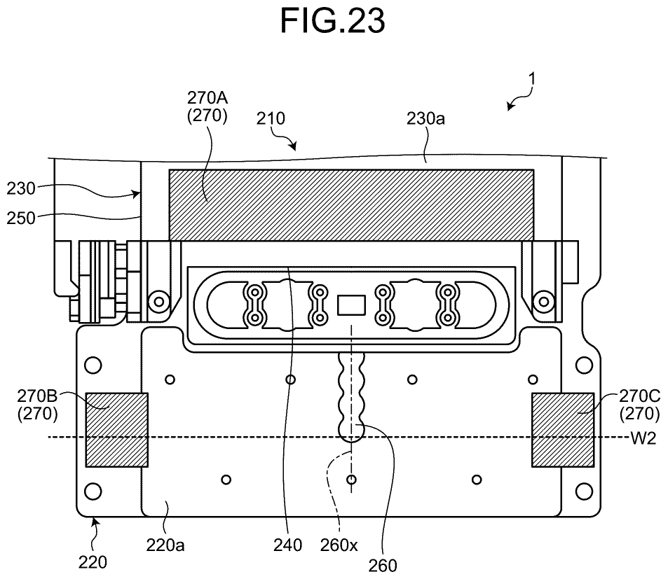

The following describes a second modification of the embodiment. FIG. 23 is a diagram of the vehicle charging device according to the second modification of the embodiment. The vehicle charging device 1 according to the second modification includes a reflection member 270 disposed on the inlet 210. The reflection member 270 has a reflection characteristic for reflecting at least the laser light LB1 and LB2. The reflection member 270 is configured to reflect the laser light LB1 and LB2 toward an incident direction of the laser light LB1 and LB2 with respect to the reflection member 270. The exemplified reflection member 270 is reflection tape including adhesive tape.

The reflection member 270 includes a first reflection member 270A, a second reflection member 270B, and a third reflection member 270C. The first reflection member 270A is disposed on the lower surface 230a of the engagement part 230. The first reflection member 270A is disposed in the vicinity of the end part 240 on the lower surface 230a. Accordingly, detection accuracy is improved at the time when the position sensor 4 performs scanning along the lines L1, L2, and L3. For example, an amount of received light of the position sensor 4 at the time of scanning the first reflection member 270A is larger than an amount of received light of the position sensor 4 at the time of scanning a portion different from the first reflection member 270A. Accordingly, the end part 240 can be detected based on both of change in a distance detected by the position sensor 4 and change in the amount of received light of the position sensor 4. Due to this, detection accuracy for the end part 240 is improved.

The first reflection member 270A extends from one end to the other end in the width direction Wd of the lower surface 230a. Accordingly, detection accuracy is improved at the time when the position sensor 4 performs scanning along the line W1. For example, the end part 250 of the engagement part 230 can be determined based on both of change in the distance detected by the position sensor 4 and change in the amount of received light of the position sensor 4.

The second reflection member 270B and the third reflection member 270C are disposed on the base part 220 of the inlet 210. The second reflection member 270B and the third reflection member 270C are disposed on both sides in the width direction Wd across the projection 260. The two reflection members 270B and 270C are disposed at symmetrical positions with respect to a center axis 260x of the projection 260. The control unit 50 according to the second modification sets a line W2 for scanning to be intersected with the two reflection members 270B and 270C. Due to this, detection accuracy for detecting the position of the projection 260 is improved.

Pieces of content disclosed in the embodiment and modifications described above can be appropriately combined to be implemented.

The vehicle charging device according to the present embodiment performs the angle control for causing the inclination angle of the connector to coincide with the inclination angle of the inlet at the time when the distal end of the connector is caused to be opposed to the opening part of the inlet. The predetermined rotational position of the support member in the angle control is a rotational position where the distal end of the connector first abuts on the inlet at the time of raising the support member, and the inclination angle of the connector coincides with the inclination angle of the inlet in a case in which the support member is raised to the target position. The vehicle charging device according to the present embodiment can cause the attitude of the connector to be the attitude matching the inclination of the inlet by raising the connector while pressing the distal end of the connector against the inlet. The vehicle charging device according to the present embodiment exhibits an effect of appropriately positioning the connector with respect to the inlet.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle charging device, comprising:
a connector that is engaged with an inlet disposed on a vehicle;
a support member;
a coupling mechanism that couples the connector with the support member, and allows the connector to change in attitude with respect to the support member;
an arm that includes a first end part coupled with the support member and a second end part supported in a rotatable manner, and raises and lowers the support member by rotating;
a driving mechanism that moves the support member, and rotates the support member; and
a control unit, wherein
the control unit performs angle control for causing an inclination angle of the connector to coincide with an inclination angle of the inlet at the time of causing a distal end of the connector to be opposed to an opening part of the inlet,
the control unit sets a rotational position of the support member to be a predetermined rotational position in the angle control, and
the predetermined rotational position is a rotational position where
the distal end of the connector first abuts on the inlet at the time of raising the support member, and
the inclination angle of the connector coincides with the inclination angle of the inlet in a case in which the support member is raised to a target position.

2. The vehicle charging device according to claim 1, further comprising:
a position sensor that detects the inlet; and
a connector sensor that outputs a detection signal in a case in which the distal end of the connector is lowered to a predetermined position determined in advance with respect to the support member, wherein
the driving mechanism includes:
a first driving mechanism that moves the arm in a first direction in a horizontal direction;
a second driving mechanism that moves the arm in a second direction in the horizontal direction;
a third driving mechanism that rotates the arm; and
a fourth driving mechanism that rotates the support member to change an angle of the connector with respect to the first direction,
the control unit acquires the inclination angle of the inlet with respect to the first direction from a detection result of the position sensor, and
the predetermined rotational position is a rotational position where the connector sensor outputs a detection signal in a case in which the support member is raised to the target position.

3. The vehicle charging device according to claim 2, wherein
the coupling mechanism includes a spring that applies, to the connector, energizing force by which the connector transitions to an attitude at an initial position, and
the predetermined position where the connector sensor outputs the detection signal is a position lower than a position of the distal end of the connector at the time when the connector is in the attitude at the initial position.
